(19) United States
(12) Patent Application Publication
(10) Pub. No.: US 2026/0049668 A1
(43) Pub. Date: Feb. 19, 2026

(54) Valve device for controlled passage of a medium, in particular in the high-pressure range

(71) Applicant: ALLFI AG, Stans (CH)

(72) Inventor: Rudolf Brunner, Ennetburgen (CH)

(73) Assignee: ALLFI AG, Stans (CH)

(21) Appl. No.: 19/206,240

(22) Filed: May 13, 2025

Related U.S. Application Data
(62) Division of application No. 18/246,136, now abandoned.

(30) Foreign Application Priority Data
Sep. 23, 2020 (CH) 01207/20

(51) Int. Cl. F16K 25/04; B26F 3/00; F16K 1/38; F16K 1/42; F16K 27/02

(52) U.S. Cl. CPC F16K 25/04; F16K 1/38; F16K 1/42; F16K 27/0254; B26F 3/004

(57) ABSTRACT

Valve device for controlled passage of a medium, in particular in the high-pressure range, which is provided with a housing having a bore, at least one inlet opening and an outlet opening; a pressure chamber formed in the bore and acted upon by the medium; and a valve needle movable to and fro therein and has a conical tip. A guide means for the valve needle, by means of which the valve needle with its circumferential region is guided directly at the conical tip almost without play and concentrically with respect to the valve seat until it is almost in the closed position, is located in a valve seat in a valve seat block. This guide means has passage openings for passage of medium from the pressure chamber into the outlet opening. Very precise guiding of the valve needle is thus achieved at the front at the tip thereof.

### CROSS-REFERENCE TO RELATED APPLICATION

This application is a divisional of U.S. patent application Ser. No. 18/246,136 filed Mar. 21, 2023, which is incorporated by reference herein.

### FIELD OF THE INVENTION

The invention relates to a valve device for controlled passage of a medium, in particular in the high-pressure range, which valve device is provided with a housing having a bore with at least one inlet opening and one outlet opening, with a pressure chamber formed in the bore and which can be acted upon by the medium, and a valve needle movable to and fro therein and which has a conical tip that can be sealingly pressed against a valve seat in a valve seat block or in the housing.

### BACKGROUND OF THE INVENTION

With a known valve device according to document EP 3 366 963 A1, a high-pressure valve is disclosed which comprises a housing having a bore, a component housed oscillatingly therein as a valve needle, and a pressure chamber formed in the bore. The valve needle can be pressed against a valve seat in the housing by a linear actuator or a spindle nut as well as by a spindle which can be actuated by hand or by machine. The housing also has a water inlet and water outlet or vice versa, which can be connected to one another via a channel when the valve is open. Additionally, a pressure disk with a bore for guiding the valve needle when closing and opening the high-pressure valve is arranged in the housing, and a sealing element, which can be acted upon by the medium and surrounds the valve needle, is attached to this pressure chamber. The valve needle is thus guided into this pressure disk and the sealing element.

However, as the valve needle is greatly stressed with the very high operating pressures of the medium and the high cycles of operation with the many to and fro movements, there is the danger that, at the front, at the conical tip, it is not pushed flush into the valve seat very precisely, and thus a partial friction occurs between its surface on the conical tip and the valve seat, and this can lead to additional wear.

### OBJECTS AND SUMMARY OF THE INVENTION

The problem of the invention is to improve this known valve device such that wear, in particular at the valve needle and the valve seat interacting with same, can be permanently prevented with a simple design, despite the heavy stresses.

This problem is solved according to the invention by a valve device for controlled passage of a medium including a housing having a bore, at least one inlet opening through which the medium is inlet into the bore, an outlet opening associated with a sleeve through which the medium is outlet from the bore, and a pressure chamber in the bore through which the medium passes. The valve device also includes a valve seat, and a valve needle movable at least partly in the pressure chamber and having a conical tip, the valve needle being movable to a closed position in which the conical tip is sealingly pressed against the valve seat to provide the valve needle with a closed position in which the medium does not flow to the outlet opening. The valve device also includes guide means for guiding the valve needle through the pressure chamber toward the valve seat until the valve needle is in the closed position, and the guide means includes at least one passage opening for passage of the medium from the pressure chamber into the outlet opening.

With the arrangement according to the invention of a guide means for the valve needle in the valve seat, in which the valve needle with its circumferential region is guided directly at the conical tip almost without play at least partially and concentrically with respect to the valve seat until it is in the closed position, a permanent, very precise guiding of the valve needle at the front at the tip thereof is achieved by this simple, efficient measure. The service life of the valve device can thus be increased. This guide means has at least one passage opening for the medium from the pressure chamber into the outlet opening.

Very advantageously, this guide means is designed in the shape of a collar or sleeve, and between this and the bore an annular space of the pressure chamber is formed in the housing. It is thus ensured that the medium can flow into the passage opening and into the outlet opening practically without resistance.

Preferably, the guide means contains four passage openings offset each by 90°, and in relation to the inner guide surfaces at which the circumferential region of the valve needle is guided, the openings have such a cross-sectional surface that, for one, the guiding of the valve needle is permanently ensured, and for another, a defined productive capacity of the medium flows through.

### BRIEF DESCRIPTION OF THE DRAWINGS

The invention, as well as further advantages of same, are illustrated below using embodiment examples with reference to the drawings. There are shown in:

FIG. 1 is a longitudinal section of a valve device according to the invention;

FIG. 2 is a perspective view of the guide means of the valve device according to FIG. 1;

FIG. 3 is a longitudinal section of a variant of a valve device according to the invention;

FIG. 4 is a perspective view of the guide means of the valve device according to FIG. 3;

FIG. 5 is a perspective view of an alternative guide means of a valve device;

FIG. 6 is a perspective view of a further guide means of a valve device;

FIG. 7 is a partial section of a valve seat and a valve needle of the valve device according to FIG. 3; and

FIG. 8 is a partial section of the valve seat according to FIG. 7 with different tapering.

### DETAILED DESCRIPTION OF THE INVENTION

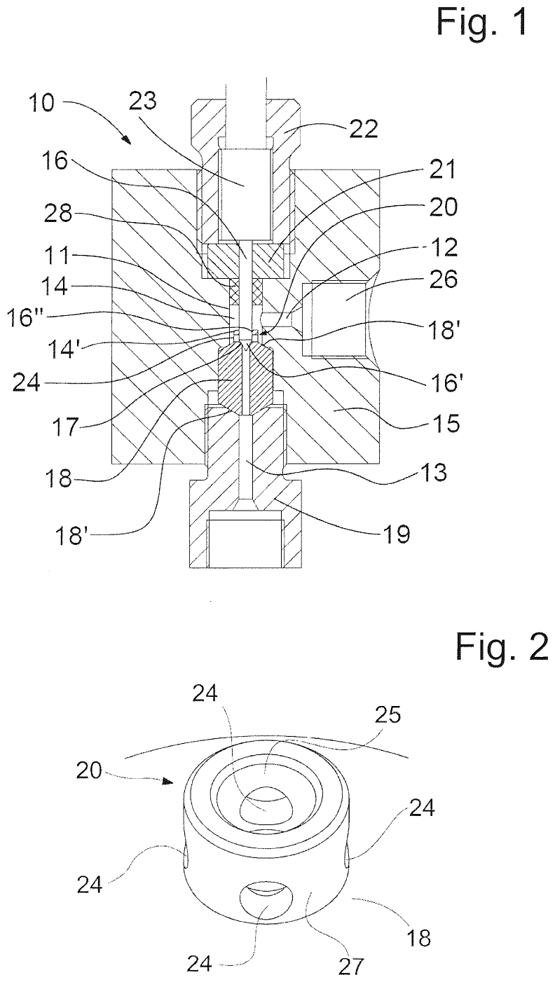

FIG. 1 shows a valve device 10 in a device for controlled passage of a medium, in particular in the high-pressure range, with pressures of up to in excess of 6000 bar. A typical range of application is devices for cutting items with a water jet provided with this high pressure.

This valve device 10 is provided with a housing 15 having a bore 11 and at least one inlet opening 12 and an outlet opening 13. In the bore 11, there is provided a pressure chamber 14 which can be acted upon by the medium and a valve needle 16 which is movable to and fro therein and has a conical tip 16′, which can be sealingly pressed against a valve seat 17 in a valve seat block 18, and thus a closing, as shown, or opening, is caused. The pressure chamber 14 in the bore 11 is in communication with the at least one inlet opening 12 when the valve device 10 is in open and closed positions and in communication with the outlet opening 13 only when the valve device 10 is in the open position such that the medium passes from the at least one inlet opening 12 into the pressure chamber 14 when the valve device 10 is in the open and closed positions (and may accumulate therein), and passes from the pressure chamber 14 to the outlet opening 13 only when the valve device 10 is in the open position.

This valve needle 16, longitudinally guided in a sealing washer 21, has a diameter in the millimeter range and is made advantageously from a hardened metal or a high-grade ceramic material. It is connected to a spindle 23 in a spindle nut 22 in the housing 15, and can be moved to and fro by hand or by machine, for example pneumatically, from this spindle 23, and in particular is closed by a spring member and pneumatically opened. The connections from the housing for supplying the medium and driving the valve needle are not shown, but are known.

The sleeve-shaped valve seat block 18 with the valve seat 17 is formed with a conical end face 18′ on each side which, when assembled, abuts against a corresponding tapered surface in the housing 15 around the bore 11 or alternately in a sleeve 19 which can be fastened in the housing 15 as sealing surfaces. The conical end faces 18′ are outward of the channel. The sleeve 19 screwed into the housing is provided with the outlet opening 13 and there can be mounted therein an outlet nozzle, not shown in more detail, for producing the water jet. The valve seat block 18 includes a channel that communicates with the outlet opening 13 formed in the sleeve 19 and through which the medium is outlet from the bore 11. The valve seat 17 surrounds one end of the channel, i.e., is inward of the first conical end face 18′. Since the valve seat block 17 has the first conical end face 18′ at one end that interacts with the tapered surface of the housing 15, it thereby seals the valve seat block 17 against the housing 15.

Moreover, an inlet opening 12 opening transversely into the bore 11 is provided in the housing 15, which inlet opening 12 is coupled, in known manner, to a pressure line for supplying the pressure medium, using a connecting sleeve 26 or the like.

According to the invention, a guide means 20 for the valve needle 16 is arranged at the valve seat 17 in the valve seat block 18. This guide means 20 is designed such that the valve needle 16 with its circumferential region 16″ connecting directly thereto is guided in front of the conical tip 16′ almost without play and concentrically with respect to the valve seat 17 until it is in the closed position, wherein this guide means 20 has a number of passage openings 24 for the medium to be guided from the pressure chamber 14 into the outlet opening 13. An annular space 14′ of the pressure chamber 14 is formed between the guide means 20 and the bore 11 in the housing 15.

In FIG. 2, the collar-shaped or sleeve-shaped guide means 20 is shown enlarged with a cylindrical generated surface 27. A cylindrical inner guide surface 25, on which the circumferential region 16″ of the valve needle 16 is guided, is designed therein. The guide means 20 contains four passage openings 24 as bores, offset each by 90° and running approximately radially therein. In relation to the inner guide surface 25, the passage openings are dimensioned with such a cross-sectional surface that, for one, the guiding of the valve needle 16 is permanently ensured, and for another, a defined productive capacity of the medium can flow through these bores.

The overall height of the sleeve forming the guide means 20 is, within the framework of the invention, advantageously dimensioned to be greater than the total travel of the valve needle 16 measured from the valve seat 17 outwards, and the valve needle 16 is thus guided into each travel position. In principle, it would be sufficient if it is surrounded at least directly above the valve seat 17 almost without play. The bores are approximately half the size of this overall height of the guide surface 25, and are arranged in the lower region of the guide means 20, with the result that the medium can flow through until right up to the closed state. The valve needle 16 is thus guided through this sealing washer 21 and this guide means 20 twice as precisely.

In the bore 11, there is also arranged a sealing sleeve 28 and, between this and the guide means 20 spaced apart therefrom, this inlet opening 12 which runs transverse is arranged in the pressure chamber 14.

The valve seat block 18 and the guide means 20 are very advantageously produced in one piece. They are usually produced by machining with the necessary precision. The valve seat 17 and at least the inner guide surface 25 are machined in the processing machine in the same fixing, with the result that the most precise concentricity between the valve needle and the valve seat can be ensured. Theoretically, the guide means 20 could be made as a separate sleeve collar, which could be fastened to the valve seat block at the valve seat with the necessary precision.

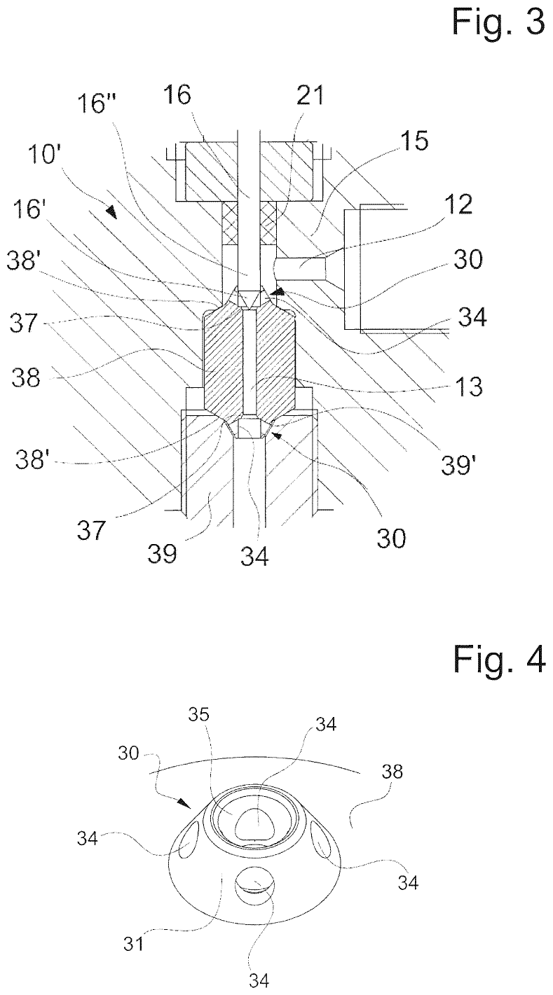

FIG. 3 and FIG. 4 show a variant of a valve device 10′ built per se the same as that according to FIG. 1. Therefore, the same reference numbers are used for the same elements, and only the differences are displayed below. Essentially, a different valve seat block 38 is used which can be fixed into the housing 15 by means of a sleeve 39. Analogously, conical end faces 38′ are formed in this valve seat block 38, which faces each abut, when assembled, against a corresponding tapered surface in the housing 15 or, alternately, on the sleeve 39, as sealing surfaces.

According to the invention, the collar-shaped guide means 30 is likewise designed such that the valve needle 16 with its circumferential region 16″ is guided directly at the conical tip 16′ almost without play into the inner guide surface 35 and concentrically with respect to the valve seat 37 until it is in the closed position. A number (four) of passage openings 34 for the medium to be guided are provided, which openings are oriented with their axis almost perpendicular to the one generated surface 31 forming a frustum. In so doing, optimized flow control of the medium is achieved from the pressure chamber 14 into the outlet opening 13.

This valve device 10′ is characterized in that, on either side of the valve seat block 38, each collar-shaped guide means 30, 30′ is associated with a valve seat 37, 37′. The two valve seats 37, 37′ are inward of the respective conical end faces 38′ of the valve seat block 38. In so doing, the valve seat block 38 can be inserted into the housing 15 in two positions rotated by 180°. For this purpose, in respect of its central plane running transverse to the outlet opening 13. it is designed to be symmetrical, i.e., the conical end faces 38′ are tapered at the same angle. Thus, after a certain amount of operating time, the valve seat block 38 can be fixed rotated by 180° if the valve seat 37 and/or the guide means 30 in use is worn.

The sleeve 39 bracing the valve seat block 38 in the housing 15 is provided with a recess 39′ within the tapered surface, in which the passive guide means 30′ is located contact-free when assembled.

As a variant, the entry-side diameter of the two opposing frustum-shaped valve seats 37, 37′ at the valve seat block 38 can be different if the tapering is the same, whereas the same valve needle 16 is used with the conical tip 16′ in the position of the valve seat block 38 rotated by 180°. In so doing, the circular sealing surface at the conical tip 16′ of the valve needle 16 is changed to a closed state after rotating the valve seat block 38, and the valve needle abuts accordingly against an almost unworn circular sealing surface in the new valve seat 37′. This results in a further increase in the service life of the valve needle 16.

According to FIG. 7 and FIG. 8, different taperings of the two opposing valve seats 37, 37′ may also be provided at the valve seat block 38, whereas the same valve needle 16 with the conical tip 16′ can be used in the position of the valve seat block 38 rotated by 180°, with the result that the circular sealing surface at the conical tip 16′ of the valve needle 16 changes after the valve seat block 38 has rotated. As illustrated in FIG. 7 or FIG. 8, the valve needle 16 rests against the inner or outer diameter Di or Da, respectively, with this different angle of inclination α, α′ of the respective frustum-shaped sealing surface of the valve seat 37 by a small angle value of approximately between 1 and 10°. If the valve needle 16 at its conical tip 16′ is worn at diameter Di, this is not the case at Da in its upper region.

In principle, either a different entry-side diameter or a different tapering to the previous one could be provided also when changing a valve seat block 18 with only one guide means 20, as shown in FIG. 1, to a new valve seat block with a guide means on only one or both side(s), meaning the same effect results as explained above with the valve seat block 38 with a valve seat 37, 37′ on each side.

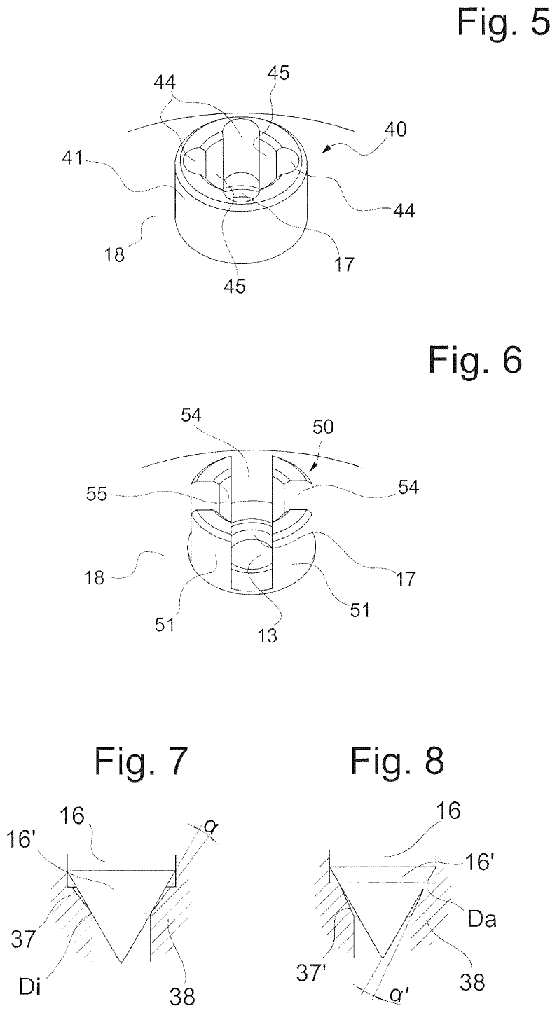

In the further embodiment example according to FIG. 5, a sleeve-shaped guide means 40 is shown which can be arranged with the valve seat 17 in the valve seat block 18 similar to that according to FIG. 1. The special feature forming the difference is the cylindrical generated surface 41 and passage openings 44 over the whole circumference, designed as recesses inside the generated surface 41 parallel to and spaced apart from the central axis. Segment-shaped inner guide surfaces 45 are thus formed in which the valve needle 16 with its circumferential region 16″ is guided almost without play and concentrically with respect to the valve seat 17 until it is in the closed position. These recesses, and correspondingly the inner guide surfaces 45, could also be produced arranged in helical rows.

FIG. 6 shows a sleeve-shaped guide means 50 which can also be arranged in the valve seat 17 in valve seat block 18, like that according to FIG. 1. The difference lies in these slot-shaped passage openings 54, which are designed permanently crosswise. Thus, similar to with guide means 40, segment-shaped inner guide surfaces 55 of segments 51 are formed into which the valve needle 16 is guided. The number of these slot-shaped passage openings 54 could also be more or less than four, and the size of same could also be less than that of the overall height.

The invention illustrated sufficiently with the above embodiment examples could self-evidently also be displayed using further variants. In this way, this guide means could be guided outwards to the bore and fastened in the housing and/or at the valve seat block. Slots or recesses would then be designed as openings of the guide means, as shown in FIG. 5 and FIG. 6.

The guide means could also be cup-shaped, dome-shaped or the like, and the preferably several passage openings could each be developed in their cross-sectional form and/or differently aligned to how they are shown.

With the two guide means 30 according to FIG. 3, such guide means according to the other Figures or two different guide means could be used, if for example a change is necessary for reasons of air flow.

1. A valve device for controlled passage of a medium to an outlet opening, comprising:
a housing having a bore, at least one inlet opening through which the medium is inlet into the bore, a pressure chamber in the bore through which the medium passes, and a tapered surface around the bore,
a sleeve-shaped valve seat block that defines a channel through which the medium is outlet from the bore and a valve seat that surrounds one end of the channel, the valve seat block having a first conical end face at the one end that interacts with the tapered surface of the housing and a second conical end face on an opposite side of the valve seat block from the first conical end face, the channel being in communication with the outlet opening,
a valve needle movable at least partly in the pressure chamber and having a conical tip, the valve needle being movable to a position in which the conical tip is sealingly pressed against the valve seat to provide the valve device with a closed position in which the medium does not flow to the channel,
guide means for guiding the valve needle through the pressure chamber toward the valve seat until the valve needle is in the position in which the conical tip is sealingly pressed against the valve seat, and
wherein the guide means includes at least one passage opening that allows passage of the medium from the pressure chamber into the channel until the conical tip is sealingly pressed against the valve seat.

2. The valve device according to claim 1, further comprising:
a sleeve that defines the outlet opening and includes a tapered surface around an inlet end of the outlet opening, the second conical end face interacting with the tapered surface of the sleeve.

3. The valve device according to claim 1, wherein the valve seat block is symmetrical in respect of its central plane running transverse to the outlet opening and the second conical end face is tapered at the same angle as the first conical end face, and therefore the first and second conical end faces are tapered at the same angle.

4. The valve device according to claim 1, wherein the valve seat is inward of the first conical end face and the valve seat block includes an additional valve seat inward of the second conical end face, the diameters of the two opposing valve seats on the valve seat block are of different size but have the same tapering, whereby the same valve needle with the conical tip can be used when the valve seat block is rotated by 180°, with the result that, after rotating the valve seat block, the circular sealing surface changes with the conical tip of the valve needle, and thus in the closed state the valve needle abuts against the valve seat with an unworn circular sealing surface.

5. The valve device according to claim 4, wherein the tapering at least of the at least one valve seat is formed on the valve seat block by a different angle of inclination compared with the conical tip of the valve needle, or that the taperings of two opposite valve seats of the valve seat block are each formed by a different angle of inclination compared with the conical tip, whereas the same valve needle can be used in the position of the valve seat block rotated by 180°, with the result that the circular sealing surface in the conical tip of the valve needle changes after rotating the valve seat block.

6. The valve device according to claim 1, wherein that the guide means is formed in the shape of a collar or sleeve, and an annular space of the pressure chamber is formed in the housing between the guide means and the bore.

7. The valve device according to claim 1, wherein, depending on the development of its passage opening, the guide means includes discontinuous cylindrical or segment-shaped inner guide surfaces, on which the circumferential region of the valve needle is guided.

8. The valve device according to claim 1, wherein the guide means includes a cylindrical or cone-shaped outer surface and the at least one passage opening runs radially and/or tangentially or at an angle to the outer surface.

9. The valve device according to claim 1, wherein the at least one passage opening consists of four passage openings offset each by 90° around the channel, and in relation to inner guide surfaces of the guide means, the cross-sectional surfaces of the four openings are such that guiding of the valve needle is ensured, and a defined productive capacity of the medium flows through.

10. The valve device according to claim 1, wherein the at least one passage opening of the guide means comprises a plurality of passage openings each connecting the pressure chamber to the outlet opening, the plurality of passage openings comprising bores, slots and/or recesses.

11. The valve device according to claim 10, wherein the generated surface of the guide means is cone-shaped and the passage openings are bores which extend with their axes approximately perpendicular to the generated surface in radial direction.

12. The valve device according to claim 10, wherein the generated surface of the guide means is cylindrical, and the passage openings within the generated surface are parallel and spaced apart from the central axis.

13. The valve device according to claim 10, wherein the passage openings are radial slots and the guide means consists of segments.

14. The valve device according to claim 1, wherein each of the guide means is provided as a separate sleeve collar, fastened in the housing or to the valve seat block.

15. The valve device according to claim 1, wherein the valve seat block defines an additional valve seat that surrounds another end of the channel and has the same tapering as the valve seat to enable the valve seat block to be insertable into the housing in two positions rotated 180°.

16. The valve device according to claim 1, wherein the valve needle is guided additionally through a sealing washer in the housing and connects to a sealing sleeve in the bore, between which sleeve and the guide means spaced apart therefrom the at least one inlet opening opening laterally into the pressure chamber is arranged.

17. The valve device according to claim 1, wherein an overall height of inner guide surfaces of the guide means is greater than a total travel of the valve needle measured from the valve seat outwards, and the valve needle is thus guided into each travel position.

18. The valve device according to claim 1, wherein the valve needle is made from a hardened metal, hard metal and/or a ceramic material.

19. The valve device according to claim 1, wherein the at least one inlet opening opens transversely into the bore and the pressure chamber is in communication with the at least one inlet opening when the valve device is in open and closed positions and in communication with the outlet opening only when the valve device is in the open position such that the medium passes from the at least one inlet opening into the pressure chamber when the valve device is in the open and closed positions and passes from the pressure chamber to the outlet opening only when the valve device is in the open position.

20. The valve device according to claim 1, wherein the valve needle includes a circumferential region and the conical tip is movable within and surrounded by the pressure chamber, the guide means being configured to guide the valve needle against the valve seat almost without play and concentrically with respect to the valve seat until the conical tip of the valve needle is against the valve seat to thereby provide the closed position of the valve.
